(19) United States
(12) Patent Application Publication
(10) Pub. No.: US 2017/0291836 A1
(43) Pub. Date: Oct. 12, 2017

(54) AUTOMATED SMART WATER PURIFICATION AND DISPENSING APPARATUS

(71) Applicant: Stephen Mark Kuzara, Eagle, ID (US)

(72) Inventor: Stephen Mark Kuzara, Eagle, ID (US)

(21) Appl. No.: 15/092,344

(22) Filed: Apr. 6, 2016

(51) Int. Cl. C02F 1/78; B67D 1/00; B67D 1/08; C02F 1/00

(52) U.S. Cl. CPC C02F 1/78; C02F 1/003; B67D 1/0004; B67D 1/0888; B67D 1/0878; C02F 2209/06; C02F 2209/22; C02F 2307/10

(57) ABSTRACT

Disclosed is an automated smart water purification and dispensing apparatus for providing purified water to a plurality of users. The water dispensed by the automated smart water purification and dispensing apparatus employs an ION purification means and an Ozone purification means for the incoming water from the water supply. The automated smart water purification and dispensing apparatus includes a display means for providing visual information and an audio output means for providing audio information to users. The subscribers of a water-dispensing scheme proposed by a central computerized controller can receive water using a storage container having an optical code that can be read using an RFID reader of the automated smart water purification and dispensing apparatus. The central computerized controller communicates with a central server in real time for transferring information about the subscribers and for controlling water dispensing accounts associated with each of the subscribers.

### FIELD OF INVENTION

The present invention relates to water purification and dispensing systems and processes for purifying and dispensing water. More particularly, the present invention relates to an automated water purification and dispensing apparatus for delivering purified water to a plurality of users.

### BACKGROUND

The amount of water available in the planet that can be used for drinking is limited. Nearly one third of the world's population does not have access to adequately clean drinking water on a regular basis. Increasingly, experts consider fresh drinking water as the most precious natural resource. Many believe we will run out of fresh drinking water before fossil fuels. As populations increase, the demand and consumption of drinking water also increases. However, the biggest threat to fresh drinking water is the development and consumerism connected to a global population increase and its corresponding increase in affluence. Rapid global increase in populations causes exponential demand for water consumption for industrial and agricultural demands. The increased demand of natural resources also results in increased pollution of existing water sources. All water sources are highly susceptible to contamination from a variety of man-made and natural sources. Bottled water offers basic filtration and the bottled water is perceived to be cleaner and healthier. However, each bottle of bottled water carries a significant carbon footprint and bottles that are collected for recycling is less. In addition, most of the bottled water is tap water and chemicals released from the plastic bottles further compromises the cleanliness of the product.

Conventional water dispensing systems for providing filtered water to the consumers includes water dispensing stations, where the customers can pay the required amount of money for receiving a particular amount of filtered water. Some other water dispensing systems enables the customers to pay early and each will be assigned with at least one water dispensing customer account. The customers will be provided with a smart card system that can be employed for receiving the required amount of filtered water from the water dispensing systems. The amount corresponding to the volume of water received will be deducted from the account of the customer. The customers can verify the balance through a website or at the retail water dispensing locations. However, these systems do not provide packaged water as part of the subscription plan within the traditional restaurant service model. Moreover, the existing systems have no means for providing the filtered water quality information to the customers. Further, these systems cannot be employed for verifying the subscriptions status of the customers at the food service locations such as restaurants. The existing systems would not allow traditional restaurants, etc. to attract, authenticate a serve patrons who have valid subscriptions to said water network.

One problem with any of these sources of bottled water is product quality. Presently there is a concern that bottled water may not be all that much better than tap water. On top of this, the various distribution systems have drawbacks. Where bottled water is sold off the shelf, there are costs involved in transporting the water from the bottled water plant, through the wholesale and retail distribution system, storing the water at warehouses and in the back room at retailers, and stocking shelves, not to mention the shelf space taken up by the product. Also, the time between when the water is produced and bottled and when the consumer purchases it may be a period of weeks and even months. Of course, leaking bottles-also cause a problem, such as when a pallet of cases of bottled water are stacked in a warehouse or the back room of a store. Moreover, the recycling of used water bottles is a major problem. It increases further costs in recycling the used bottles and it also increases the carbon footprint in the environment.

One problem of water quality is of course when the purification is not complete. However, if all impurities are removed from the water, it may have a reduced pH that then causes the water to leach minerals or other harmful components from processing equipment, storage containers, and even the body when the water is consumed. It is a common experience to open a container of bottled water and find that is has acquired an off taste, especially when stored in some plastic containers.

Point of sale dispensing of water overcomes some of the drawbacks of other bottled water distribution systems, but also presents new problems. First, because the dispensing equipment is used by the public, it is subject to contamination. Also, even if the water is purified, there is no control over the cleanliness of the container into which it is dispensed. Often, to reduce costs, many water purification and dispensing systems have a small processing capacity coupled with a storage tank. Thus, water is purified on a slow, continuous basis, but is stored to meet demand. These large storage systems present long holding times that are not conducive to water purity, and if the tanks are not sealed, to the possibility of contamination.

Hence there exists a need for improved water purifying and dispensing apparatus. The needed improved water purifying and dispensing apparatus would allow registered subscribers to receive purified water from the water dispensing system. Further the needed apparatus would identify registered users using optical machine code printed on bottle seal. Moreover the needed apparatus would deduct the amount of water automatically from retail food service provider monthly bill to water filter company. The needed apparatus would allow the users to view the real time data about the reduction in carbon footprint and effect to the environment when receiving water from the apparatus. Further, the needed apparatus would allow retail shops, restaurants, etc. to function as a subscriber-access point for a water filter company's filtered water. In addition, the needed apparatus would enable the point of access capabilities to enable instant subscriber verification and food service entity billing adjustments. The needed apparatus would allow the subscriber's to access real-time water quality values and would enable the customers to verify the quality of the filtered water at retail food service provider offering said filtered water.

### SUMMARY

The present invention is an automated smart water purification and dispensing apparatus for providing purified water to a plurality of users. The water dispensed by the automated smart water purification and dispensing apparatus employs environment friendly methods for filtering and dispensing purified water. The automated smart water purification and dispensing apparatus for providing purified water to a plurality of users mainly comprises at least one water purification system for filtering a plurality of contaminants present in water received from a water source, at least one storage means in fluid communication with the at least one water purification system for storing purified water by the at least one water purification system and a plurality of water spouts for delivering filtered water to the at least one water storage container. The automated smart water purification and dispensing apparatus is housed in a rigid housing. The housing provides good aesthetic appearance to the automated smart water purification and dispensing apparatus and hence it can be used at office or any public location.

The at least one water purification system of the automated smart water purification and dispensing apparatus includes an ION purification means and an Ozone purification means for the incoming water from the water supply. The ION purification means includes an ION tank and ION chiller coil. The ION purification means is in fluid communication with the at least one storage means provided with the bottom portion of the automated smart water purification and dispensing apparatus. The water purified by the ION purification means is collected by the storage means. The ozone purification means includes an O2 reactor, O2 storage tank and O2 chiller coil. The water from the incoming water supply is fed to the ozone purification means and after filtration the purified water will be stored in the storage means.

The automated smart water purification and dispensing apparatus further includes at least one display means for providing a plurality of information to at least one user and at least one audio output means for providing a plurality of audio information to the at least one user. The plurality of information can be interactively displayed on specific areas of the display means. The audio associated with the visual information is provided through the at least one audio output means provided on the front or sides of the housing of the automated smart water purification and dispensing apparatus. The automated smart water purification and dispensing apparatus includes at least one camera module for providing assistance for remote service operation of the automated smart water purification and dispensing apparatus. The automated smart water purification and dispensing apparatus further includes at least one activation means for ozone cleaning of at least one water storage container of the at least one user before filling purified water from it. The at least one water storage container is provided with an at least one optical machine code, i.e. preferably an RFID identification means provided on an external surface of the container for identification of a subscribed user with the filtering company's water dispensing system. The at least one RFID reading means provided with the automated smart water purification and dispensing apparatus can be employed for detecting and extracting the at least one optical machine code attached with the at least one water storage container. The purified water can be collected from the plurality of waterspouts. The automated smart water purification and dispensing apparatus includes multiple water spouts for delivering filtered water using different filtering means provided with the smart water purification and dispensing apparatus to the at least one water storage container of the at least one subscriber. The housing of the automated smart water purification and dispensing apparatus has a base portion for conveniently supporting the at least one water storage container below the plurality of water spouts for receiving filtered water in the at least one water storage container.

Other objects and advantages of the embodiments herein will become readily apparent from the following detailed description taken in conjunction with the accompanying drawings.

### BRIEF DESCRIPTIONS OF THE DRAWINGS

FIG. 1 is a diagram showing an automated smart water purification and dispensing apparatus for providing purified water to a plurality of users, according to a preferred embodiment of the present invention.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical, electrical and other changes may be made without departing from the scope of the embodiments. The following detailed description is therefore not to be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The description provided herein is complete and sufficient for those skilled in the arts of water purification systems, computer systems, software application development, smartphone application development and web development to implement the methods as described. Our automated smart water purification and dispensing apparatus is in communication with a server running an operating system such as Windows, Linux, web-server software such as Apache, and database such as MySQL, with methods implemented through a software development language such as PHP or Java. However, the invention should not be limited to these types of software operating system, web-server software, database software, software development language, server or client hardware.

The amount of water available in the planet that can be used for drinking is limited. About one third of the world population does not have access to clean drinking water. The availability of drinking water from natural resources is also diminishing due to increased water consumption by individuals and industries. The adverse changes in environmental conditions also affects the natural sources of drinking water. The available water from the natural water sources such as lakes, rivers and other underground sources are contaminated from a variety of natural and man made contaminants. Water treatment facilities filters the water received from these natural resources and delivers to the household consumers and industries. Existing water treatment facilities are not equipped to filter modern day contaminants such as, but not limited to, industrial solvents, industrial additives, process chemicals, pesticides, fertilizers, agricultural additives and a broad variety of human pharmaceuticals. These contaminants are in some cases are undetected and extremely harmful to the health of people when regularly consumed. Additional human activity such as mining and oil/gas drilling has recently been connected to numerous cancer causing agents to spread in natural sources of water. Water treatment facilities available around the world usually add chlorine and fluoride to the water by utilities in order to reduce bacteria or organics and to promote better dental hygiene. However, both chlorine and fluorine are forms of harmful chemicals that have been linked to a variety of serious and growing health conditions such as autism, diabetes and several forms of cancer. Chlorine added at municipal water treatment facility may also react further with the municipal plumbing infrastructure and with the natural organic matter and with biofilms, which is commonly present in the pipes. Ozone used to disinfect water may produce potentially harmful byproducts and produces ketones, carboxylic acids, and aldehydes, including formaldehyde. Bromide in source waters can be converted by ozone into bromate, which is a potent carcinogen. Because of these potential carcinogens as byproducts of common water treatment techniques commonly used by municipalities, existing systems cannot be used to get pure drinking water.

Packaged drinking water is perceived to be cleaner and healthier. However, the large-scale bottled water consumption increases the carbon footprint in the world and the amount of bottles that is recycled for reuse is less. Moreover, the disposable plastic bottles used for the packaged water proved to be compromising the quality and purity of the water stored therein and in some worst cases the plastic storage bottles are causing additional chemical mixing with the stored water. Due to the varieties of contaminants in the natural sources of water, the existing methods cannot be effectively used for detecting the toxic elements and filtering the water. The present invention discloses an automated smart water dispensing system that employs at least one digital dynamic sensor array (DDSA) that can detect hundreds of primary or relevant threat elements found in the water ways, natural sources of water and in packaged water products. The automated smart water dispensing system further includes a purification system that is capable of removing the plurality of contaminants present in the incoming water supply using different types of purification means such as ION purification and Ozone purification.

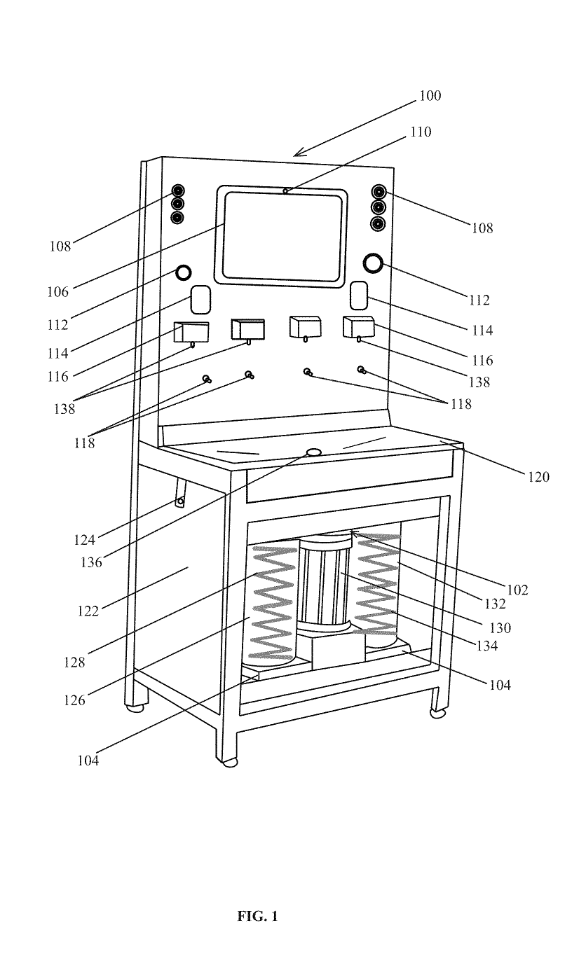

FIG. 1 is a diagram showing an automated smart water purification and dispensing apparatus 100 for providing purified water to a plurality of users, according to a preferred embodiment of the present invention. The automated smart water purification and dispensing apparatus 100 is intended for use in a home or office or any public location. The automated smart water purification and dispensing apparatus 100 has an attractive closed housing, which prevents insects and dust and provides purified water to a plurality of users. The water dispensed by the automated smart water purification and dispensing apparatus 100 employs environment friendly methods for filtering and dispensing purified water, which has superior quality compared to the existing systems. The automated smart water purification and dispensing apparatus 100 performs automatic filtration of incoming water supply and includes at least one storage means of sufficient capacity for storing purified water before dispending to the plurality of users. The automated smart water purification and dispensing apparatus 100 keeps track of the quality and quantity of water dispensed to each user and contributes to the safety of the environment by reducing carbon footprint.

The automated smart water purification and dispensing apparatus 100 for providing purified water to a plurality of users mainly comprises at least one water purification system 102 for filtering a plurality of contaminants present in water received from a water source, at least one storage means 104 in fluid communication with the at least one water purification system 102 for storing purified water by the at least one water purification system 102 and a plurality of water spouts 116 for delivering filtered water to the at least one water storage container. The automated smart water purification and dispensing apparatus 100 is housed in a rigid housing made of metallic and or plastic components. The housing provides good aesthetic appearance to the automated smart water purification and dispensing apparatus 100 and hence it can be used at office or any public location. The automated smart water purification and dispensing apparatus 100 further includes at least one display means 106 for providing a plurality of information to at least one user and at least one audio output means 108 for providing a plurality of audio information to the at least one user. The plurality of information can be interactively displayed on specific areas of the display means 106. The audio associated with the visual information is provided through the at least one audio output means 108 or the speakers provided on the front or sides of the housing of the automated smart water purification and dispensing apparatus 100. In certain embodiments, the automated smart water purification and dispensing apparatus 100 includes at least one camera module 110 for providing assistance for remote service operation of the automated smart water purification and dispensing apparatus 100. At least one service personal can perform the service of the automated smart water purification and dispensing apparatus 100. The camera 110 can be placed above the display unit 106 for face-to-face interaction of the remote personal and the service personal performing the service of the automated smart water purification and dispensing apparatus 100. The automated smart water purification and dispensing apparatus 100 further includes at least one activation means 112 for ozone cleaning of at least one water storage container of the at least one user before filling purified water from it. In a preferred embodiment, the at least one water storage container is provided with an at least one optical machine code, i.e. preferably an RFID identification means provided on an external surface of the container for identification of a subscribed user with the automated smart water purification and dispensing apparatus 100. The at least one RFID reading means 114 provided with the automated smart water purification and dispensing apparatus 100 can be employed for detecting and extracting the at least one optical machine code attached with the at least one water storage container. The purified water can be collected from the plurality of water spouts 116. The automated smart water purification and dispensing apparatus 100 includes multiple water spouts 116 for delivering filtered water using different filtering means provided with the smart water purification and dispensing apparatus 100 to the at least one water storage container of the at least one subscriber. The housing of the automated smart water purification and dispensing apparatus 100 has a base portion 120 for conveniently supporting the at least one water storage container below the plurality of water spouts 116 for receiving filtered water in the at least one water storage container.

In an embodiment of the present invention, the automated smart water purification and dispensing apparatus 100 is enclosed in a housing, which is made of steel or any other durable material. The housing of the automated smart water purification and dispensing apparatus 100 has a bottom portion and a top portion. The bottom portion has the at least one water purification system 102 and the at least one storage means 104 in fluid communication with the at least one water purification system 102, both can be accessible by opening a door 122 attached with the bottom portion of the housing. In an embodiment, the door 122 is hinged to the side surface and locked using a locking means 124. The service personal can open the door 122 by unlocking the locking means 124 for service and maintenance. The top and bottom portion of the housing has sufficient strength to withstand the weight of water and the plurality of filtration and purification components placed inside it. The frame structure of the hosing may be made from strong metallic materials such as steel, and the bottom portion of the housing rests on footrests provided at its bottom. In some instances the footrests are attached with casters for allowing easy movement of the automated smart water purification and dispensing apparatus 100 without much physical effort.

The at least one water purification system 102 includes an ION purification means and an Ozone purification means for the incoming water from the water supply. The ION purification means includes an ION tank 126 and ION chiller coil 128. The ION purification means is in fluid communication with the at least one storage means 104 provided with the bottom portion of the automated smart water purification and dispensing apparatus 100. The water purified by the ION purification means is collected by the storage means 104 positioned below it. The ozone purification means includes an O2 reactor 130, O2 storage tank 132 and O2 chiller coil 134. The water from the incoming water supply is fed to the ozone purification means and after filtration the purified water will be stored in the storage means 104 positioned below it. In some other embodiments of the present invention, the automated smart water purification and dispensing apparatus 100 is provided with multiple storage means 104, each for storing the filtered or purified water using a particular purification means, such as, but not limited to, ION purification and O2 purification. The purified water using different technologies will be stored separately inside their respective storage means 104.

The bottom portion of the automated smart water purification and dispensing apparatus 100 i.e. the at least one water purification system 102 includes the digital dynamic sensor array (DDSA) capable of being operating based on a remote central computer-based monitoring system. The digital dynamic sensor array is in communication with the remote central computer-based monitoring system for contaminant element value interpretation and weighting to generate interpretable water quality values across a broad range of changing targeted elements. The DDSA includes sensor probes that reside in-line with the incoming water supply for detecting the plurality of contaminants with the incoming water supply, which otherwise cannot be identified using existing methods. Each of the sensor probes are controlled by independent micro-controller boards that control the sensor probes and translate average contaminant levels (ACL) and sends the information to a main controller board. The main controller board processes the plurality of information received from the independent micro-controller boards and sends the plurality of information to the central computer-based monitoring system for computer-based element value interpretation and weighting of the contaminants levels. The variable dynamic sensor probe array includes a plurality of element specific sensors capable of detecting contaminants in an incoming water line that are present in the incoming water supply and specific to a particular region due to industrial and agricultural activities. The element specific sensors in the variable dynamic sensor probe array are configured to detect at least one contaminant in the water caused by agricultural and industrial activities in a particular area such as mining and oil exploration. The runoff and tailing chemicals from the mining areas may contaminate the water sources and the element specific sensors in the variable dynamic sensor probe array can be employed to detect the presence of such chemicals in the water. In addition, the element specific sensors in the variable dynamic sensor probe array can be employed to detect chemicals in areas where known deficiencies in treatment infrastructure exist. These element specific sensors in the variable dynamic sensor probe array include sensors capable of detecting human or animal pharmaceutics. The element specific sensors in the static sensor array and in the variable dynamic sensor probe array of DDSA includes, but not limited to, sensors for total dissolved solids, fluoride, Chlorine, potential hydrogen, dissolved oxygen, temperature, bromide, etc. The number of element specific sensors in the static sensor array and in the variable dynamic sensor probe array of DDSA can be increased to detect new contaminating elements. The digital dynamic sensor array (DDSA) allows adding new element specific sensors for detection of contaminants in the water, its presence cannot be determined using conventional systems. The series of in-line digital sensor probes of the DDSA is embedded within a manifold structure for targeting and recording levels of their specific target element. A software application running in the remote central computer-based monitoring system weights importance of detected contaminant levels and allows the system to generate a general water quality value, in the order of, 1-100. The various elements detected by the element specific sensors associated with the independent micro-controller boards will be weighted differently based on known health risks and levels. In some embodiments, the water quality value will be displayed on the at least one display means with any other information for allowing the users to understand about the quality of water being dispensed through the automated smart water purification and dispensing apparatus 100.

The top portion of the housing of the automated smart water purification and dispensing apparatus 100 includes the at least one display means 106 or a display screen coupled with the at least one audio output means 108 positioned on either sides of the display screen. The plurality of information displayed on the at least one display means 106 includes, but not limited to, at least one water quality information about the purified water, quantity of purified water being dispensed, environmental information, subscriber information and at least one advertisement. In an embodiment, the area of the display means 106 is divided into different sections to show several categories of information, such as the DDSA water quality index on a left side of the display means 106, environmental and saving in carbon footprint real time information onto the right side of the display means 106 and a central part of the display means 106 for video presentation and online advertisement. In some other embodiments, the information displayed in the display means 106 can be controlled by at least one user by using at least one control switch provided with the automated smart water purification and dispensing apparatus 100 and accessible to the user. The user can select different information such as, contaminant levels in purified water, pH of purified water, as desired by the user. In some other embodiments, the display means 106 is a touch screen display allowing a user to access a plurality of real time information from the automated smart water purification and dispensing apparatus 100. The plurality of information displayed on the at least one display means 106 is controlled by the central computer system, which in turn is controlled from a remote central monitoring system in communication with the automated smart water purification and dispensing apparatus 100 over a communication channel.

The automated smart water purification and dispensing apparatus 100 includes a variety of hardware and associated software components, where the variety of hardware components include the central computer system having at least one processing unit designed to control various other circuits such as information displayed on a display unit 106, controller for water dispensing from a plurality of water spouts 116 to the at least one water storage container, etc. The processing unit may control the information based on inputs received from various input-output (I/O) devices of the automated smart water purification and dispensing apparatus 100 e.g. hard keys, a touch screen, and/or from some other user input device.

The central computerized controller for controls a plurality of operations of the automated smart water purification and dispensing apparatus 100, which includes detection of contaminants by the plurality of sensors, purification of water from the water source, at least one water quality information about the purified water, information displayed on the at least one display means 106, at least one subscriber information and environmental information, etc. The central computerized controller of the automated smart water purification and dispensing apparatus 100 communicates with the remote central monitoring system over the communication channel, which can be a wireless communication means and wired communication means. The central computerized controller sends a plurality of information including water quality levels, pH levels and Oxygen levels to the remote central monitoring system in real-time, etc. to the remote server unit or the remote central monitoring system over a wireless communication channel. The remote central monitoring system remotely monitors and controls water quality, pH levels and Oxygen levels, etc. in real time for delivering pure water free from contaminants to the at least one user.

The central computerized controller can be connected to a remote central monitoring system, which is the central server of the water dispensing systems. The remote central monitoring system or the central server may run a software application for managing the operations of a plurality of automated smart water purification and dispensing apparatus 100 remotely and in real time. The software application can verify the subscription status of users, accounts of the retail water dispensing system or point of sale locations where the automated smart water purification and dispensing apparatus 100 is installed, can verify billing information of the subscribers, etc. The remote central monitoring system or the central server has at least one database of all the customers registered into a retail water dispensing system comprising the plurality of automated smart water purification and dispensing apparatus 100. The database stores the account information of each customer including the purchase information and billing information. The application running in the remote central monitoring system or the central server may further allow the user or the POS service person to access a payment gateway associated with the server to verify or receive payment from at least one customer for accessing the automated smart water purification and dispensing apparatus 100. The central computer system in the automated smart water purification and dispensing apparatus 100 can perform a plurality of operations including scanning the at least one unique optical machine code such as a bar code, QR code etc. provided on the container or the bottle using the RFID reader 114. The central computer system associated with the automated smart water purification and dispensing apparatus 100 may be used to access the remote server, at which an instantiation of a computer-based application, which provides the network-based and other features associated with the water dispensing system, may be installed and accessible. Such access may be by way of a computer network or communication networks, such as the network of networks commonly known as the Internet. In some cases, the communication network includes a local and/or wide area network or mobile communication network. In other instances, the communication network may be a local area network (LAN) of an enterprise and/or a virtual LAN, which is instantiated over the Internet or other networks of networks. The remote central server or the central monitoring system is communicatively coupled to the database, which may store records concerning customer credentials, user ratings, water quality information, historical water quality measurements, and credits, feedback details, etc.

The at least one subscriber to the water dispensing system associated with the automated smart water purification and dispensing apparatus 100 can scan the optical machine code on the exterior surface of the water storage container using the at least one RFID reading means 114 provided on the top portion of the housing of the automated smart water purification and dispensing apparatus 100. Scanning the optical machine code on the exterior surface of the water storage container retrieves information about the subscription status of the customer from the remote central computer system or the central server. The optical machine code contains a plurality of information including a water quality information, water quantity information for the filtered water received from at least one point of access retail outlet associated with a filtered water service provider, filtered date and time and information for verifying a service establishment of a customer with the filtered water service provider. Before filling water, the at least one activation means 112 of the automated smart water purification and dispensing apparatus 100 can be accessed by the at least one user for ozonized cleaning of the at least one water storage container. Now the user can place the water storage container or the bottle below the respective water dispensing nozzle of the water spout 116 for delivering filtered water to the at least one water storage container. The automated smart water purification and dispensing apparatus 100 includes multiple water spouts 116 for delivering purified water using different methods such as pure water, ION purified water and Oxygen water purification system for ozonized water. The at least one user can receive purified water from the desired water spouts 116 by activating at least one water dispending switch 118 associated with the respective water spout 116. In an embodiment of the present invention, the filtered water from the water company's automated smart water purification and dispensing apparatus 100 is provided to a valid subscriber for free, while the unregistered subscriber will be required to pay full retail price for said bottle of water. The amount of water received by the validated subscriber will be deducted from the retail service bill of the service customer and the volume of water dispensed is deducted from a monthly bill of the food service provider.

The base portion 120 of the automated smart water purification and dispensing apparatus 100 is positioned below the plurality of water spouts 116 and includes a drain hole 136 for removing excess water from the base portion 120. In some embodiments, the plurality of waterspouts 116 includes a sparling means for providing a visual indication of the use of it while filling water inside the water storage container. In an embodiment of the present invention, the at least one water purification system 102 for removing the plurality of contaminants present in water received from the water source includes, but not limited to, ION water purification system for providing ION purified water and Oxygen water purification system for ozonized water.

The automated smart water purification and dispensing apparatus 100 delivers purified water to the plurality of users and validates retail food service customer's subscription status and performs brokering of intermediary billing adjustments for the filtered water dispensed and served by the retail food service provider. The automated smart water purification and dispensing apparatus 100 automatically authenticate and serve water network subscribers by scanning the optical machine code printed on bottle seal. When a successful authentication is completed using the RFID reader 114 of the automated smart water purification and dispensing apparatus 100, the purified water is dispensed to the container through the nozzle 138 of the water spout 116. Thereafter the amount of water dispensed to the user is automatically adjusted or deducted from retail food service provider monthly bill to water filter company. The automated smart water purification and dispensing apparatus 100 automatically and instantly verify a subscription status of the customer after scanning the optical machine code on the water bottle seal, which will initiate an authentication request to water filter manufacturer company's cloud-based remote central server. Further, the automated smart water purification and dispensing apparatus 100 allows retail shops, restaurants, etc. to function as a subscriber-access point for a water filter company's filtered water. In addition, the automated smart water purification and dispensing apparatus 100 enables the point of access capabilities to enable instant subscriber verification and food service entity billing adjustments. The automated smart water purification and dispensing apparatus 100 allow the subscribers to access real-time water quality values and would enable the customers to verify the quality of the filtered water at retail food service provider offering said filtered water.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the appended claims.

Although the embodiments herein are described with various specific embodiments, it will be obvious for a person skilled in the art to practice the invention with modifications. However, all such modifications are deemed to be within the scope of the claims.

1. An automated smart water purification and dispensing apparatus for providing purified water to a plurality of users comprising:
at least one water purification system for filtering a plurality of contaminants present in water received from a water source;
at least one storage means in fluid communication with the at least one water purification system for storing purified water by the at least one water purification system;
at least one display means for providing a plurality of information to at least one user;
at least one audio output means for providing a plurality of audio information to the at least one user;
at least one camera module for providing assistance for remote service operation of the automated smart water purification and dispensing apparatus;
at least one activation means for ozonized cleaning of at least one water storage container;
at least one RFID reading means for detecting and extracting at least one optical machine code attached with the at least one water storage container;
a plurality of water spouts for delivering filtered water to the at least one water storage container; and
a base portion for conveniently supporting the at least one water storage container below the plurality of water spouts for receiving filtered water in the at least one water storage container.

2. The automated smart water purification and dispensing apparatus of claim 1 wherein the at least one water purification system includes a plurality of sensors residing in-line with an incoming water supply from the water source for detecting the presence of the plurality of contaminants.

3. The automated smart water purification and dispensing apparatus of claim 1 wherein the plurality of water spouts includes an ION water spout for providing ION purified water, Oxygen water spout for ozonized water, and water spouts for delivering highly purified water to the at least one user.

4. The automated smart water purification and dispensing apparatus of claim 1 wherein the plurality of information displayed on the at least one display means includes at least one water quality information about the purified water, quantity of purified water being dispensed, environmental information, subscriber information and at least one advertisement.

5. The automated smart water purification and dispensing apparatus of claim 1 wherein the plurality of information displayed on the at least one display means can be controlled by at least one control switch accessible to the user.

6. The automated smart water purification and dispensing apparatus of claim 1 wherein the plurality of information displayed on the at least one display means is controlled from a remote central monitoring system in communication with the automated smart water purification and dispensing apparatus over a communication channel.

7. The automated smart water purification and dispensing apparatus of claim 1 includes a central computerized controller for controlling a plurality of operations including detection of contaminants by the plurality of sensors, purification of water from the water source, at least one water quality information about the purified water, information displayed on the at least one display means, at least one subscriber information and environmental information.

8. The automated smart water purification and dispensing apparatus of claim 7 wherein the central computerized controller is in communication with the remote central monitoring system over the communication channel,
wherein the communication channel includes wireless communication means and wired communication means.

9. The automated smart water purification and dispensing apparatus of claim 7 wherein the central computerized controller sends a plurality of information including water quality levels, pH levels and Oxygen levels to the remote central monitoring system in real-time,
wherein the remote central monitoring system remotely monitors and controls water quality, pH levels and Oxygen levels in real time for delivering pure water free from contaminants to the at least one user.

10. The automated smart water purification and dispensing apparatus of claim 1 wherein the at least one activation means can be accessed by the at least one user for ozonized cleaning of the at least one water storage container.

11. The automated smart water purification and dispensing apparatus of claim 1 wherein the water storage container is provided with the optical machine code on an exterior surface.

12. The automated smart water purification and dispensing apparatus of claim 1 wherein the optical machine code contains a plurality of information including a water quality information, water quantity information for the filtered water received from at least one point of access retail outlet associated with a filtered water service provider, filtered date and time and information for verifying a service establishment of a customer with the filtered water service provider.

13. The automated smart water purification and dispensing apparatus of claim 1 wherein the plurality of water spouts includes a water dispensing nozzle for delivering filtered water to the at least one water storage container.

14. The automated smart water purification and dispensing apparatus of claim 1 wherein the at least one user can receive purified water from the plurality of water spouts by activating at least one water dispending switch associated with the respective water spout.

15. The automated smart water purification and dispensing apparatus of claim 1 wherein the base portion includes a drain hole for removing excess water from the base portion.

16. The automated smart water purification and dispensing apparatus of claim 1 wherein the at least one water purification system for removing the plurality of contaminants present in water received from the water source includes ION water purification system for providing ION purified water and Oxygen water purification system for ozonized water.

17. The automated smart water purification and dispensing apparatus of claim 1 wherein the at least one water purification system for removing the plurality of contaminants present in water received from the water source is positioned inside the automated smart water purification and dispensing apparatus allowing access by at least one service person.

18. The automated smart water purification and dispensing apparatus of claim 1 wherein the plurality of water spouts for delivering filtered water to the at least one water storage container is arranged with a visual indication means for allowing the at least one user to visualize the operation.

19. The automated smart water purification and dispensing apparatus of claim 1 wherein the plurality of users is a plurality of subscribers of a water dispensing scheme proposed by the central computerized controller,
wherein the central computerized controller stores a plurality of information about the plurality of subscribers and controls at least one water dispensing account associated with each of the plurality of subscribers.
